(19) United States
(12) Patent Application Publication
(10) Pub. No.: US 2026/0170229 A1
(43) Pub. Date: Jun. 18, 2026

(54) Effective Document Editing Workflow Systems and Methods

(71) Applicant: DocJuris Inc., Houston, TX (US)

(72) Inventor: Henal M Patel, Houston, TX (US)

(73) Assignee: DocJuris Inc., Houston, TX (US)

(21) Appl. No.: 19/122,735

(22) PCT Filed: Oct. 19, 2023
(86) PCT No.: PCT/US2023/035549

§ 371 Date: Apr. 19, 2025

Related U.S. Application Data
(60) Provisional application No. 63/418,348, filed on Oct. 21, 2022.

(51) Int. Cl. G06F 40/103; G06F 40/166; G06Q 10/101

(52) U.S. Cl. CPC G06F 40/103; G06F 40/166; G06Q 10/101

(57) ABSTRACT

Systems and methods for effective document editing workflow management. A document is digitally tagged with one or more alteration parameters. At least one alteration parameter includes a tag to lock at least one section in the document from alteration while permitting alteration of at least one other section in the document. The tagged document is distributed via a communication network. Alterations to the tagged document are tracked, and a separate document is rendered in a selected format representing the alterations. A playbook may be used to analyze the document.

### CROSS REFERENCE TO RELATED APPLICATIONS

National stage application of International Application No. PCT/US2023/035549 filed on Oct. 19, 2023, which claims priority from U.S. Provisional Application No. 63/418,348 filed on Oct. 21, 2022. The foregoing applications are incorporated herein by reference in their entirety.

### FIELD OF THE INVENTION

The present disclosure relates generally to the field of digital document processing. More particularly, this disclosure relates to methods and systems for digitally preparing, reviewing, and editing documents in a controlled manner.

### BACKGROUND

Analyzing and editing documents can be a difficult and time-consuming task prone to errors if not carefully undertaken. In situations where multiple reviewers provide input in the editing process, version control can be difficult and document revisions can easily get confused. Drafters or reviewers may go through a number of revised document versions before a finalized version is accepted by all parties. Certain documents, such as legal contracts, introduce additional complexity to the editing process. In the business world, legal contract amendments cannot be avoided. The formal process of amending a contract is necessary because contracts are legally binding. Anytime a change is needed for a contract that has been executed (i.e., signed by the parties), the contract needs to be formally amended to ensure it continues to be binding and, therefore, enforceable.

There are two common ways to initiate or send a document for review, negotiation, and execution. FIG. 1 shows a conventional way of distributing or sharing documents using conventional software. A first party 2 (e.g., an attorney, contract administrator, team leader, etc.) on a computing device 4 creates or pulls up a digital document D1 for distribution to others P2, P3, P4 for review. The first party 2 will typically send the first draft D1 as an open Word™ document, or locked PDF™ document for e-signature.

An enormous gap of intent exists between an open Word™ document or locked PDF™ document, and hours, days, and weeks are lost because of one simple issue-the format of the document. Each approach (Word™ vs. PDF™) serves different purposes, but procurement teams are often stuck with a binary choice that has scale limiting disadvantages. While there are some conventional document sharing packages, these are generally internal collaboration tools and are not designed for negotiating with an external party. Thus, conventional applications are inherently asynchronous.

When it comes to using a Word™ document, problems and challenges with drafts include:
An open Word™ document invites unlimited commentary and redlines. Even the most disciplined and “business friendly” reviewer will find it difficult to skip over key terms.
Documents in Word™ provide no initial guidance or boundaries on what's negotiable. The typical result is a sea of red on the first cut.

Word™ documents are not secure. Track changes can be turned off, and the underlying document code can be modified by anyone in the review group. In some cases, provisions can be made hidden even with track changes on or they can be modified to appear (or not appear) in clean mode. Applicable locking features are also ineffective as restrictions can be overcome or removed by cutting and pasting documents.

Reminders, formatting, and data points are lost. When viewing a general document, there is no sense of urgency or deadline, and time spent on template formatting is not considered

When it comes to using a PDF™ document, problems and challenges with drafts include:
As an alternative or “more secure” path, teams might consider a PDF™ as the brute force approach to a contract negotiation. This approach creates more problems:
   The moment a PDF™ is received by a reviewer, there is an immediate requests for a Word document. On average, this wastes 1-4 days of time.
PDFs will be messily converted. There are conventional applications that can decrypt, unlock, perform optical character recognition, and convert a PDF™ to a Word™ document. Typically, converted PDFs strip formatting and create more problems than if a Word™ document had been sent in the first place.

Upfront work on behalf of the counterparty is generally required. Rather than substantive feedback of the document terms, teams seek feedback about the counterparty. This is not practical for business contracts that require feedback and negotiation.

Returning to FIG. 1, each external party P2, P3, P4 will typically send back to the first party 2 a marked-up or edited document D2, D3, D4 reflecting a modified version of original document D1, which will require compilation, summarization, and analysis that may take weeks or longer to complete. This process becomes even messier and more protracted when one or more of the external parties P2, P3, P4 passes the document(s) D1, D2, D3, D4 to others (e.g., outside counsel) for additional review and editing.

Thus, a need remains for improved techniques to efficiently and effectively prepare, review, and edit documents, particularly in a commercial group environment.

### SUMMARY

According to an aspect of the invention, a system for editing a document includes at least one processor configured with instructions to perform digital functions including to: input digital data representing a document; digitally tag at least one selected alteration parameter to the document, wherein the at least one selected alteration parameter includes a tag to lock at least one section in the document from alteration while permitting alteration of at least one other section in the document; provide access to the tagged document via a communication network; digitally track alterations made to the tagged document; and digitally render a separate document in a selected format, wherein the selected format represents alterations made to the document.

According to other aspects of the invention, a method for editing a document includes inputting digital data representing a document in a computational domain; in the computational domain, digitally tagging at least one alteration parameter to the document, wherein the at least one alteration parameter includes a tag to lock at least one section in the document from alteration while permitting alteration of at least one other section in the document; providing access to the tagged document via a communication network; digitally tracking alterations made to the tagged document; and digitally rendering a separate document in a selected format, wherein the selected format represents alterations made to the document.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments disclosed herein. Consequently, a more complete understanding of the present embodiments and further features and advantages thereof may be acquired by referring to the following description taken in conjunction with the accompanying drawings, in which like reference numerals may identify like elements, wherein:

FIG. 1 illustrates a conventional workflow for distributing and editing a document.

FIG. 2 is a schematic of a system providing a communication network configuration according to an example of the present disclosure.

FIG. 3 is a schematic of a document workflow according to an example of the present disclosure.

FIG. 4 is a schematic of another document workflow according to an example of the present disclosure.

FIG. 5 is a schematic of a document workflow including a playbook according to an example of the present disclosure.

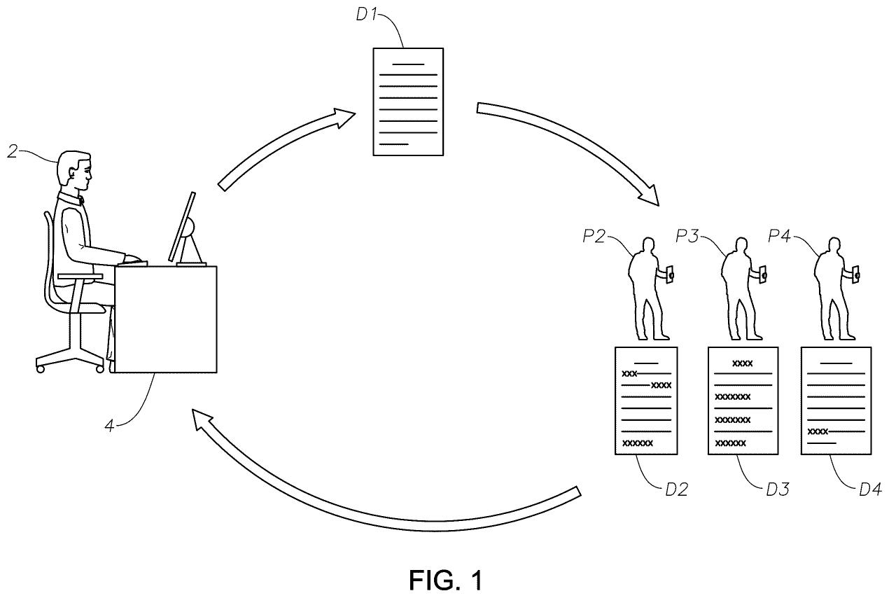

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, in the interest of clarity all features of an actual implementation may not be described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The following detailed description of exemplary embodiments, read in conjunction with the accompanying drawings, is merely illustrative and is not to be taken as limiting the scope of the invention. It will be understood that as used herein, the terms “digital” and “digitally” define a creation or rendering by means of digital or computer technology.

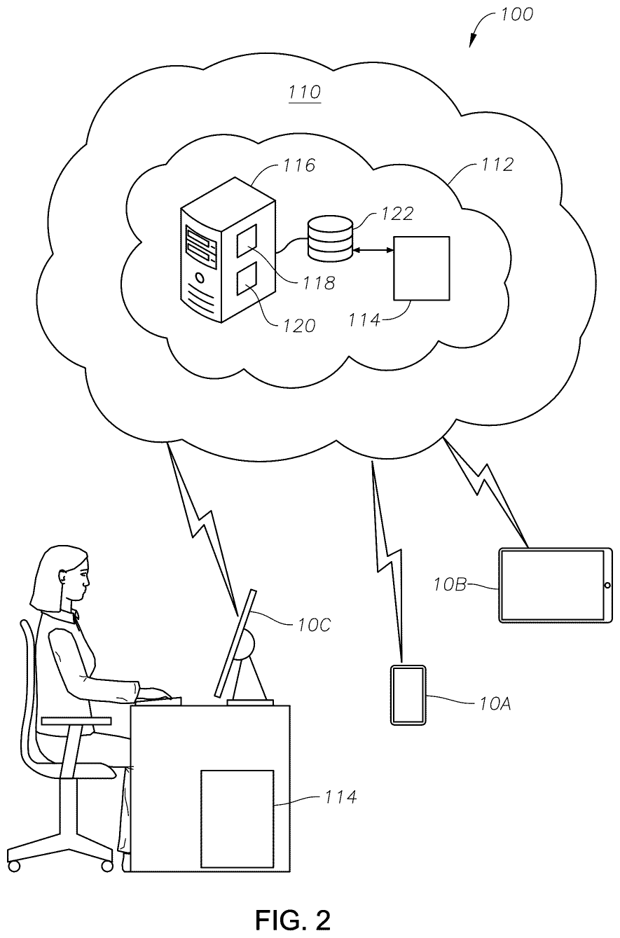

FIG. 2 shows a system 100 consistent with example embodiments of this disclosure. The system 100 includes a communication network 110 that provides communication links between one or more computing devices such as a mobile smart phone 10A, a tablet computer 10B, and a desktop or laptop computer 10C. The computing devices are conventional devices equipped with a visual display. The communication network 110 may be the Internet, an intranet, a wired or wireless network, a Wi-Fi network, a cellular network, or any combination thereof. The system 100 defines a computational domain 112 including an application module 114, a server 116 configured with one or more processors 118 and a memory module 120 (transitory and non-transitory). Some embodiments may also include a database 122. The computational domain 112 may be implemented as a closed architecture (e.g., linked to an established number of entities) or as a cloud-based architecture. Use of the term “cloud” in this context refers generally to conventional cloud computing, which is a paradigm of computing in which dynamically scalable and often virtualized resources may be provided as a service over the network 110.

The software constructs enabling the embodiments of this disclosure reside in the application module 114. Embodiments of the software code may be implemented using conventional programming languages as known in the art (e.g., JAVA™, PYTHON™, C, C++, etc.). It will be appreciated by those skilled in the art that the application module 114 may be implemented with a single software program or a group of programs designed to perform the functions of the disclosed embodiments. The computational domain 112 may be implemented with conventional computer hardware (e.g., server systems) situated in one location or via a distributed cloud-based network.

Those skilled in the art will appreciate that the embodiments of this disclosure may be practiced in network 110 computing environments with many types of computer system configurations, including, desktop computers, laptop computers, personal computers, message processors, hand-held devices, multi-processor systems, microprocessor-based or programmable consumer electronics, network PCs, minicomputers, mainframe computers, and conventional cellphones. Embodiments may also be practiced in distributed computational domains 112 where local and remote computer systems, which are linked (either by hardwired data links, wireless data links, or by a combination of hardwired and wireless data links) through a network 110, both perform tasks. In a distributed system environment, application modules 114 may be located in both local and remote memory using conventional memory constructs (e.g., local memory, virtual memory, and/or cloud-based memory).

In some embodiments, an interface application associated with the application module 114 may be temporarily resident in non-transitory memory of the individual computing devices 10A, 10B, 10C and executable via the internal processor(s) in the devices. Updates to the application module 114 on the computing devices 10A, 10B, 10C can be installed via the communication network 110. Embodiments may be implemented using conventional memory constructs (e.g., local memory, virtual memory, and/or cloud-based memory).

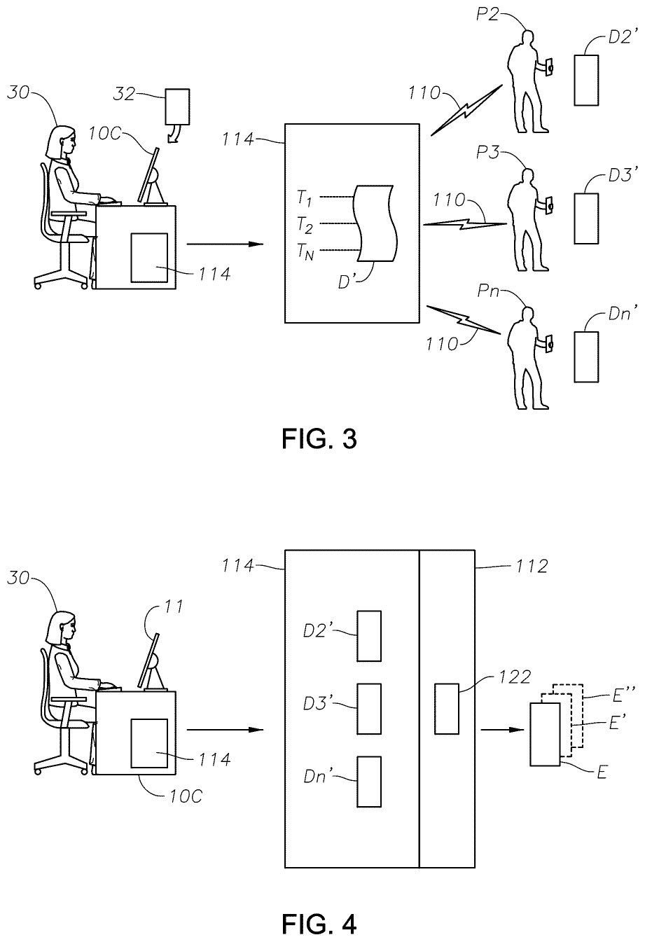

FIG. 3 shows an embodiment workflow of this disclosure. A user 30 creates or uploads digital data representing a document 32 into a computing device such as a computer 10C configured with an application module 114 or linked through the communication network 110 to the application module as disclosed herein. The document 32 may be digitally input via the computer 10C keyboard or audio dictation software, transmitted via the communication network 110, or uploaded locally (e.g., via flash drive, CD, etc.). The document 32 may be in a format from a conventional word processing application (e.g., Word™, PDF™, etc.). Once input, the user 30 can make any desired changes (e.g., via the computing device keyboard or dictation software). The user 30 can also digitally tag the document 32 with one or more alteration parameters T₁, T₂ . . . Tₙ. The user 30 can select from different types of alteration parameters T₁, T₂ . . . Tₙ to digitally tag the document 32, including:

Locked tag—One or more sections of the document 32 may be digitally “locked” such that a reviewer cannot make any changes to the locked section. A “section” may comprise user 30 selected text, specific sentences, a paragraph, tables, lists, figures, enumerated items, or any other discernible character depicted in the document 32.

Restricted tag—One or more sections of the document 32 may be digitally restricted such that a reviewer cannot delete any characters but can add text to the restricted section(s) in the document 32.

Comment tag—One or more sections of the document 32 tagged with a Lock tag or a Restricted tag may be digitally enabled to accept and record comments associated with such tagged sections as input by a reviewer. It will be understood that others can generally make comments to other un-tagged sections in the document 32 whether or not the respective section(s) is tagged with a Comment tag. The Comment tag enables others to input commentary relating to locked or restricted sections in a document 32.

Time tag—The entire contents of the document 32 or separate sections of the document may be designated to track and record the time spent by a party respectively viewing and/or altering the document. The application module 114 uses the clock in the respective computing device 10A, 10B, 10C to time stamp and log the time spent on the individual section(s) in the document 32 once accessed.

No Export tag—The entire document 32 file can be restricted from subsequent conveyance (e.g., cannot forward via email, cannot copy-paste) by the recipient of the document from the user 30.

No Printing tag—The entire document 32 file can be restricted from printing of the document by the recipient of the document from the user 30.

Unless tagged with a Lock tag or a Restricted tag, a recipient of the document 32 is free to make amendments directly to the document (digitally recorded as tracked changes) and can add comments to the document sections as described herein.

Document 32 tagging takes place in the computational domain 112, wherein a virtual document D′ is created and saved as elected by the user 30. The application module 114 creates the virtual document D′ from user 30 input when the user creates a new document or when the module automatically revisualizes an uploaded document from its existing format (e.g., a Word™, PDF™, Excel™, etc.) to create the virtual document D′.

The virtual document D′ is in essence a unique hybrid open-locked document. Once the document 32 has been prepared or uploaded and tagged as desired by the user 30, the user can kick off a simple counterparty workflow by making the tagged document D′ accessible to others. For example, the user 30 can save the tagged document D′ in the computational domain 112 and send a hyperlink to external parties P2, P3 . . . Pn via the communication network 110, as shown in FIG. 3. It will be appreciated that a user 30 can establish and make accessible different versions of the document D′ to different external party members. For instance, the user 30 can set tags T₁ and T₂ to a document D′ accessible by external party P2 and only tag T₁ to the document D′ accessible by external party P3.

Once the external party Pn receives the hyperlink, the tagged document D′ can be accessed, reviewed, and edited as permitted by the respective tags T₁, T₂ . . . Tₙ placed on the document by the user 30. The application module 114 captures all key strokes and inputs made by the external party Pn to the tagged document D′ as it is edited. Some embodiments calculate the location of every change and input made to the tagged document D′ and automatically save the data representing those changes. Some embodiments of the application module 114 designate the areas of the tagged document D′ and automatically label and save the data representing corresponding designated areas, sections, or ranges to mirror the areas, sections, or ranges as designated or labeled in the tagged document D′. For example, a tagged document D′ might include expressly designated areas or sections, such as a recitals section, numbered paragraphs, sub-numbered lists, multiple exhibits, a signature block, etc. The application module 114 may automatically designate these areas and save the data in order to ensure the changes represented in the digital document file accessible by the user 30 correspond directly with the designated areas, sections, and/or ranges in the tagged document D′. Once the external parties P2 . . . Pn make their redlines and enter comments to the documents D′, the application module 114 automatically saves the respective revised document Dn′ file(s) in the computational domain 112 for user 30 access.

A key advantage of embodiments of this disclosure is the ability to summarize and condense the alterations made to the documents Dn′ by the external parties Pn. Turning to FIG. 4, an embodiment of the application module 114 is depicted. Upon alteration of the tagged document D′ and rendering of the revised document(s) Dn′ by the external parties Pn, embodiments of this disclosure provide a user 30 the ability to automatically render a separate document E in a selected format representing the alterations and comments made to the documents. The user 30 can customize the changes represented on the separately rendered document E. For example, a tagged document D′ might have an outlined Terms and Conditions section and an Exhibit schedule. After the external party Pn has altered the tagged document D′, the user 30 can access the edited document Dn′ and select the entire contents or a specific section or item in the edited document to include in the rendered document E. Following with the above example, the user 30 can open the edited document Dn′ and select the Terms and Conditions section. The application module 114 will then automatically render the separate document E depicting only the altered Terms and Conditions section in a format selected by the user 30.

The user 30 can select the format of the separately rendered document E from various options (e.g., exception table, spreadsheet, amendment, table, letter, contract, exhibit, etc.). The user 30 can view the separate document E on the device 10C screen 11, save the document as a file, and/or export the separate document (e.g., email distribution). Pre-defined format templates E′, E″ for the separate document E, to represent and incorporate the changes made to the tagged document D′, can reside in the database 122 or other memory location. A user 30 can add or update customized templates for the separate document E to create a library of document formats as desired.

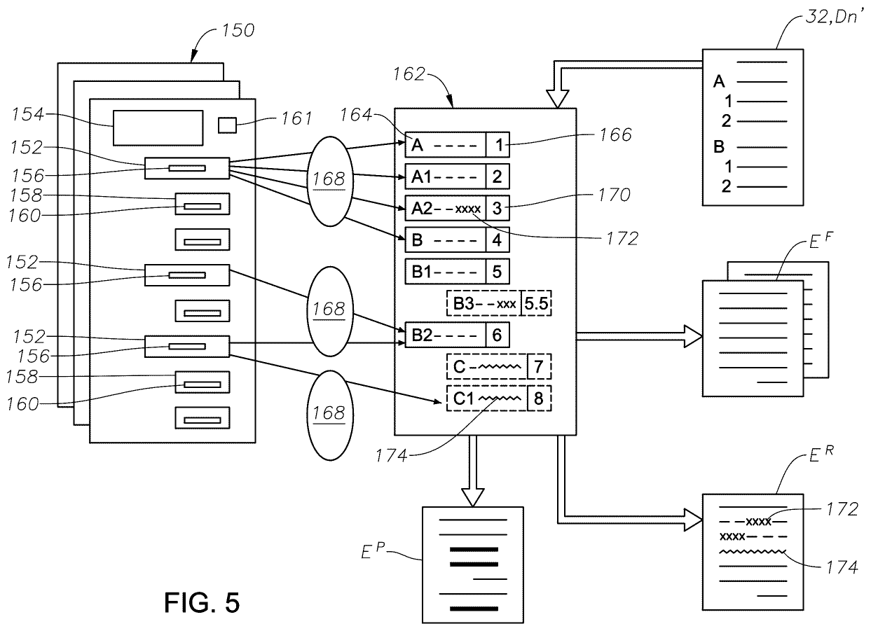

In some embodiments, the application module 114 applies a playbook to provide an automated review and analysis of the edited document(s) Dn′. A playbook is a compilation of issues representing items of interest to the user 30 in the review and editing of the particular document. FIG. 5 shows a schematic of a playbook 150 in accordance with embodiments of this disclosure. In some embodiments, one or more playbooks 150 may be stored in the database 122 or other memory location. A playbook 150 is essentially a customized set of detailed instructions or a checklist that contains issues 152 which provide the user 30 guidance in reviewing/editing a document 32 for tagging and/or a revised document Dn′ received from another party. When enabled by a user 30, the playbook 150 is displayed for the user (e.g., on the screen 11 side-by-side with the document 32 to be tagged or the edited document Dn′). Once the playbook 150 is selected by the user 30, the playbook automatically compares or analyzes the document to be tagged 32 or the edited document Dn′ against the issues 152 checklist in the respective playbook.

For example, for applications with legal documents an embodiment of this disclosure may comprise a playbook 150 with a compilation of issues 152 common to the legal profession (e.g., preferred positions, counter-party positions, statutory clauses, definitions, etc.). A preferred position may define company standards and organization risk mitigation practice. Counter-party positions may define how a counter party may view an issue and provides guidance on how to respond to the counter position. Examples may be to accept, reject, or offer a different counter to the counter position. Upon opening a playbook 150 comprising legal issues 152 the playbook automatically compares or analyzes the document to be tagged 32 or the edited document Dn′ against the issues checklist in the playbook.

In some embodiments, a playbook 150 comprises description information 154 and one or more issues 152, each having a preferred position 156. Each issue 152 has associated one or more counter positions 158. Each counter position 158 has guidance 160 for how the counter position should be accepted, rejected, or modified by the user in an attempt to achieve the preferred position 156, or get closer to it such that the final position is acceptable to the parties.

As previously described, a user 30 can create customized templates for the separate document E. For example, a user may want the separate document E to have a specific opening paragraph, some boiler plate text, specifically defined terms, etc. The user 30 can create and save these customized form templates (e.g., as individual information packets or markers 161). When editing a document 32, Dn′, the user 30 can pick one or more desired markers 161 to drop into the document so that the separate document E will include the information from the marker at the precise location where the user inserted the marker. FIG. 5 depicts a playbook 150 embodiment including a tab under which the user-established information packets or markers 161 are saved and can be selected as desired by a user 30 to edit a document.

A document 32 to be tagged or an edited document Dn′ is parsed into sections 162, as described herein. The sections 162 are tagged with a unique identifier 164 and an order 166. The sections 162 are associated with issues 152 in the playbook 150 by key phrases or keywords 168. A user 30 may navigate through the sections 162 by selecting issues 152 from the playbook 150, which will show sections 162 associated by the keywords 168 with the issue. If multiple sections 162 are associated with the selected issue 152, then the user can sequentially navigate through each of the sections. As an example, the schematic in FIG. 5 shows that the first issue 152 in the list is associated with the sections tagged as A, A1, A2, and B.

A user 30 may navigate through the document 32 to be tagged or an edited document Dn′ by selecting a section 162, which will show the issues 152 from the playbook 150 associated by the keywords 168 with the section 162. If multiple issues 152 are associated with the selected section 162, then the user 30 can sequentially navigate through each of the issues. As an example, the schematic in FIG. 5 shows that section B2 is associated with the second and the third issue 152 in the list.

As a user 30 modifies the sections 162 of the document 32 to be tagged or an edited document Dn′, changes are indicated by a status tag 170. The status tag 170 may indicate that text has been edited 172 or that text has been inserted 174. The ordering tags 166 may be modified as sections are inserted or rearranged. As an example, see that section B3 has been inserted between sections 162 with ordering tag 5 and 6, and therefore has an ordering tag 5.5. It will be appreciated that Arabic numbering does not have to be used for tagging with embodiments of this disclosure. As an example, a linked list structure may be utilized to accomplish the same task so that when the user 30 chooses to export or output the separate document E, all sections are in order.

As previously discussed, embodiments of this disclosure may produce multiple types of output documents E, such as a final formatted ready-to-execute separate document E^{F} for presentation to the parties, or a redlined copy E^{R} (indicating edits 172 and inserts 174) for use in negotiations, or a private copy E^{P} which includes notes on guidance and counter positions from the playbook 150 which the user 30 may reference during negotiations.

In some embodiments, a user 30 can build and scale the playbook(s) 150 via the application module 114. Users can: associate a playbook 150 with a document type (e.g., different contract document types); establish a standard form template in the playbook 150 for comparison and analysis of documents 32, Dn′; create and enter details for issue 152 lists; create and edit customized information markers 161, and update or revise previously created playbooks 150 as desired. Upon accessing a document 32, Dn′ as disclosed herein, the application module 114 can automatically analyze the document and display the different form templates in the playbooks 150 associated with the particular document type. The user 30 can select from among the automatically listed form templates or pick another specific form template in the playbook 150 forms library. Users 30 can also designate which other parties can access, navigate, and/or modify the created playbook(s) 150.

In some embodiments, a core playbook 150 may be established by the user 30. For example, for contract document editing a core playbook 150 may include standard issues included in essentially every contract (e.g., standard boilerplate language and clauses). A core playbook 150 may be copied as a starting point and edited rather than beginning each playbook from nothing and duplicating work previously done in other playbooks. In some embodiments, a core playbook 150 may be applied along with a transaction specific playbook. Joining two playbooks 150 together and applying the resultant as a single playbook can make it easier to update or change core issues across a wide range of transactions. When joining playbooks 150, a user 30 may include instructions on handling potential conflicts among issues 152 and guidance recommendations.

Advantages of the disclosed embodiments include facilitating lightning fast collaboration between multiple parties, perfectly drafted markups, and knowledge capture that scales. At the outset, applications of the disclosed embodiments empower teams with a collaborative and privileged workspace between business stakeholders, in-house personnel, and outside parties. Each document review can be co-authored with clause based granularity, and internal comments can be sorted and reviewed based on the user's role in the negotiation. The native analysis and integration features make it easy for teams to approve/reject. Adding to the efficiency is a drafting pane that removes the noise and normalizes all formatting and styling in a document.

In an online survey (performed by the present Applicant) of 250+ contracting professionals, it was revealed that 50% of document redlines originate at the beginning of a negotiation, and, more broadly, 86% of a contracting professional's time is spent on review, redlining, and negotiation. Embodiments of this disclosure facilitate extensive integrations, with returned document feedback that expedites notifications and approvals without the pain of endless email chains and meetings. Dynamic checklists and playbooks with drafter's notes, fallbacks, and deviation guidance are made available with just a few clicks.

By application of the disclosed embodiments, a user no longer needs to spend days or weeks compiling and summarizing document editions. The customized and automatically rendered separate documents cut the time it takes to summarize a document redline analysis from days to minutes. The ability to restrict or block certain document editing while allowing full editing of other sections in a document streamlines negotiation and avoids wasted time for all parties. Reports and ready-for-execution documents can also be easily configured for direct email delivery without convoluted intervention.

It will be appreciated by those skilled in the art that the disclosed embodiments may be implemented using conventional software and computer systems programmed to perform the disclosed processes and operations. The present invention may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, or other transmission media (e.g., light pulses passing through a fiber-optic cable).

Computer readable program instructions described herein can be downloaded to respective computing/processing devices from a computer readable storage medium or to an external computer or external storage device via a network 110, for example, the Internet, a local area network, a wide area network, a wireless network, and/or a cloud-based network. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer entirely on the remote computer or server, over a cloud-based network, or via a combination of the foregoing.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In light of the principles and example embodiments described and illustrated herein, it will be recognized that the example embodiments can be modified in arrangement and detail without departing from such principles. For example, alternative embodiments may include processes that use fewer than all of the disclosed operations, processes that use additional operations, and processes in which the individual operations disclosed herein are combined, subdivided, rearranged, or otherwise altered. It will also be appreciated that embodiments of this disclosure may be implemented for use with documents composed of or containing information in any language. In view of the wide variety of useful permutations that may be readily derived from the example embodiments described herein, this detailed description is intended to be illustrative only, and should not be taken as limiting the scope of the invention.

What is claimed is:

1. A system for editing a document, comprising:
at least one processor configured with instructions to perform digital functions including to:
input digital data representing a document;
digitally tag at least one selected alteration parameter to the document,
wherein the at least one selected alteration parameter includes a tag to lock at least one section in the document from alteration while permitting alteration of at least one other section in the document;
provide access to the tagged document via a communication network;
digitally track alterations made to the tagged document; and
digitally render a separate document in a selected format,
wherein the selected format represents alterations made to the document.

2. The system of claim 1 wherein the functions performed by the at least one processor include a function to record comments input by a user relating to the at least one locked section in the document.

3. The system of claim 1 wherein the digitally rendered separate document is in a format selected from among an amendment, a table, a letter, or a contract.

4. The system of claim 1 wherein the digital functions performed by the at least one processor are performed in a computational domain.

5. The system of claim 1 wherein the tagged document consists of a virtual document.

6. The system of claim 1 wherein the functions performed by the at least one processor include a function to perform an analysis of the input digital data representing the document.

7. The system of claim 6 wherein the document analysis comprises analysis using a digital playbook.

8. The system of claim 1 wherein the accessible tagged document is configured such that it cannot be printed.

9. The system of claim 1 wherein the functions performed by the at least one processor further include a function to track time spent by a user when viewing and/or altering the tagged document.

10. The system of claim 9 wherein the function to track time is configured to track time spent on separate sections in the tagged document.

11. A method for editing a document, comprising:
inputting digital data representing a document in a computational domain;
in the computational domain, digitally tagging at least one alteration parameter to the document,
wherein the at least one alteration parameter includes a tag to lock at least one section in the document from alteration while permitting alteration of at least one other section in the document;
providing access to the tagged document via a communication network;
digitally tracking alterations made to the tagged document; and
digitally rendering a separate document in a selected format,
wherein the selected format represents alterations made to the document.

12. The method of claim 11 further comprising recording comments input by a user relating to the at least one locked section in the document.

13. The method of claim 11 wherein the digitally rendered separate document is in a format selected from among an amendment, a table, a letter, or a contract.

14. The method of claim 11 wherein the tagged document consists of a virtual document.

15. The method of claim 11 further comprising performing an analysis of the input digital data representing the document.

16. The method of claim 15 wherein the document analysis comprises analysis using a digital playbook.

17. The method of claim 11 wherein the accessible tagged document is configured such that it cannot be printed.

18. The method of claim 11 further comprising tracking time spent by a user when viewing and/or altering the tagged document.

19. The method of claim 18 wherein tracking time comprises tracking time spent on separate sections in the tagged document.

20. The method of claim 11 wherein providing access to the tagged document comprises providing access to one or more selected users.
